(19) United States
(12) Patent Application Publication
(10) Pub. No.: US 2026/0166953 A1
(43) Pub. Date: Jun. 18, 2026

(54) Remote System And Method For Regulating Temperature Of Operator Cabin Of Work Machine

(71) Applicant: Caterpillar Inc., Peoria, IL (US)

(72) Inventors: Sreekanth Chakravarthy Gomadam, Nanganallur (IN); Gowtham Kumar, Puducherry (IN); Pradheep Arumugam Shanmugasundaram, Ganapathy (IN); Aswak Shanavaz, Tiruppur (IN); Vijeendra Nadgir, S.N. Pet (IN)

(21) Appl. No.: 19/404,277

(22) Filed: Dec. 1, 2025

(30) Foreign Application Priority Data
Dec. 16, 2024 (IN) 202411099451

(51) Int. Cl. B60H 1/00; E02F 9/08

(52) U.S. Cl. CPC B60H 1/00778; B60H 1/00878; E02F 9/0858; B60Y 2200/41

(57) ABSTRACT

A remote system for regulating a temperature of an operator cabin of a work machine includes a controller which determines if at least one door and at least one window of the work machine are closed, determines that a current temperature of the operator cabin is outside of a desired temperature range, determines that a current voltage of a battery system of the work machine is above a predetermined threshold, determines that a parking brake of the work machine is in an applied state, and turns ON a power source and an HVAC system of the work machine based on determining that the door and the is closed, the current temperature of the operator cabin is outside of the desired temperature range, the current voltage of the battery system is above the predetermined threshold, and the parking brake is in the applied state.

### CROSS-REFERENCE TO RELATED APPLICATIONS

This application claims priority to prior India Patent Application Number 202411099451, filed Dec. 16, 2024, which is incorporated herein by reference in its entirety.

### TECHNICAL FIELD

The present disclosure relates to a work machine. More particularly, the present disclosure relates to a remote system for regulating a temperature of an operator cabin of the work machine and a method for remotely regulating the temperature of the operator cabin of the work machine.

### BACKGROUND

In cold environments, or due to conditions encountered in winters, an operator cabin of a work machine may become inhabitable due to low temperatures within the operator cabin. These low temperatures are generally lesser than an ideal body temperature that is approximately in a range of 36-37 degrees Celsius or 98-99 degrees Fahrenheit. In such a scenario, an operator would be required to physically enter the operator cabin, turn ON an engine of the work machine and turn ON a heating, ventilation, and air conditioning (HVAC) system of the work machine to warm the operator cabin. Further, it may be desirable to turn ON the engine to pre-heat the engine, especially in extreme cold conditions, where cold cranking is necessary. Heating of the engine may ensure that the work machine is ready for operation.

Contrastingly, in regions that experience high temperatures, such as arid or coastal regions, operators may be required to physically enter the operator cabin, turn ON the engine, and turn ON the HVAC system in order to allow the HVAC system to cool the operator cabin. If the temperature of the operator cabin is outside of an ideal temperature range, the operator may experience discomfort and may cause the operator to be less productive.

U.S. Pat. No. 10,011,156, hereinafter referred to as ‘the '156 reference’, describes a method for controlling a vehicle cabin climate. The method of the '156 reference includes receiving and aggregating data relating to one or more inputs, wherein at least some of the data is acquired at the vehicle and some of the data is acquired from sources located remotely from the vehicle. The method further includes using a climate control module to determine an optimal cabin climate based on the aggregated data and controlling one or more climate features according to the optimal cabin climate.

However, the method from the '156 reference is only designed to cool or warm up the cabin of the vehicle without complying with a standard operating procedure that accounts for maximum operational efficiency of the vehicle while considering a safety protocol so as to maintain maximum safety of the vehicle and any persons in a vicinity of the vehicle.

### SUMMARY

In an aspect of the present disclosure, a remote system for regulating a temperature of an operator cabin of a work machine is disclosed. The remote system includes at least one door lock sensor coupled to at least one door of the work machine. The at least one door lock sensor is configured to generate a first input signal that indicates if the at least one door is open or closed. The remote system also includes at least one window lock sensor coupled to at least one window of the work machine. The at least one window lock sensor is configured to generate a second input signal that indicates if the at least one window is open or closed. The remote system further includes a temperature sensor disposed within the operator cabin. The temperature sensor is configured to generate a temperature signal that indicates a current temperature of the operator cabin. The remote system includes a voltage detection sensor coupled to a battery system of the work machine. The voltage detection sensor is configured to generate a voltage signal that indicates a current voltage of the battery system. The remote system also includes a parking brake sensor coupled to the work machine. The parking brake sensor is configured to generate a parking brake signal that indicates if a parking brake of the work machine is in an applied state. The remote system further includes a controller in communication with each of the at least one door lock sensor, the at least one window lock sensor, the temperature sensor, the voltage detection sensor, and the parking brake sensor. The controller is configured to wirelessly receive, from a user, a user input to turn ON a heating, ventilation, and air-conditioning (HVAC) system of the work machine. The controller is also configured to determine whether the at least one door of the work machine is open or closed based on the first input signal received from the at least one door lock sensor. The controller is further configured to determine whether the at least one window of the work machine is open or closed based on the second input signal received from the at least one window lock sensor. The controller is configured to determine whether the current temperature of the operator cabin is outside of a desired temperature range based on the temperature signal received from the temperature sensor. The controller is also configured to determine whether the current voltage of the battery system is above a predetermined threshold based on the voltage signal received from the voltage detection sensor. The controller is further configured to determine whether the parking brake of the work machine is in the applied state so as to prevent a movement of the work machine based on the parking brake signal received from the parking brake sensor. The controller is configured to turn ON a power source of the work machine if the at least one door is closed, the at least one window is closed, the current temperature of the operator cabin is outside of the desired temperature range, the current voltage of the battery system is above the predetermined threshold, and the parking brake of the work machine is in the applied state. The controller is also configured to determine if the power source is in an operational state. The controller is further configured to turn ON the HVAC system of the work machine to regulate the current temperature of the operator cabin so as to lie within the desired temperature range if the power source is in the operational state.

In another aspect of the present disclosure, a method for remotely regulating a temperature of an operator cabin of a work machine is disclosed. The method includes generating, by at least one door lock sensor coupled to at least one door of the work machine, a first input signal that indicates if the at least one door is open or closed. The method also includes generating, by at least one window lock sensor coupled to at least one window of the work machine, a second input signal that indicates if the at least one window is open or closed. The method further includes generating, by a temperature sensor disposed within the operator cabin, a temperature signal that indicates a current temperature of the operator cabin. The method includes generating, by a voltage detection sensor coupled to a battery system of the work machine, a voltage signal that indicates a current voltage of the battery system. The method also includes generating, by a parking brake sensor coupled to the work machine, a parking brake signal that indicates if a parking brake of the work machine is in an applied state. The method further includes wirelessly receiving, by a controller, a user input to turn ON a heating, ventilation, and air-conditioning (HVAC) system of the work machine from a user. The controller is in communication with each of the at least one door lock sensor, the at least one window lock sensor, the temperature sensor, the voltage detection sensor, and the parking brake sensor. The method includes determining, by the controller, whether the at least one door of the work machine is open or closed based on the first input signal received from the at least one door lock sensor. The method also includes determining, by the controller, whether the at least one window of the work machine is open or closed based on the second input signal received from the at least one window lock sensor. The method further includes determining, by the controller, whether the current temperature of the operator cabin is outside of a desired temperature range based on the temperature signal received from the temperature sensor. The method includes determining, by the controller, whether the current voltage of the battery system is above a predetermined threshold based on the voltage signal received from the voltage detection sensor. The method also includes determining, by the controller, whether the parking brake of the work machine is in the applied state so as to prevent a movement of the work machine based on the parking brake signal received from the parking brake sensor. The method further includes turning ON, by the controller, a power source of the work machine if the at least one door is closed, the at least one window is closed, the current temperature of the operator cabin is outside of the desired temperature range, the current voltage of the battery system is above the predetermined threshold, and the parking brake of the work machine is in the applied state. The method includes determining, by the controller, if the power source is in an operational state. The method also includes turning ON, by the controller, the HVAC system of the work machine to regulate the current temperature of the operator cabin so as to lie within the desired temperature range if the power source is in the operational state.

In yet another aspect of the present disclosure, a work machine is disclosed. The work machine includes a frame. The work machine also includes a power source mounted on the frame and configured to provide an operating power supply to one or more components of the work machine. The work machine further includes an operator cabin mounted on the frame. The work machine includes at least one door coupled to the operator cabin. The work machine also includes at least one window coupled to the operator cabin. The work machine further includes a battery system configured to provide an electric power supply to one or more components of the work machine. The work machine includes a parking brake. The work machine also includes a heating, ventilation, and air-conditioning (HVAC) system configured to at least one of heat and cool the operator cabin. The work machine further includes a remote system for regulating a temperature of the operator cabin. The remote system includes at least one door lock sensor coupled to the at least one door. The at least one door lock sensor is configured to generate a first input signal that indicates if the at least one door is open or closed. The remote system also includes at least one window lock sensor coupled to the at least one window. The at least one window lock sensor is configured to generate a second input signal that indicates if the at least one window is open or closed. The remote system further includes a temperature sensor disposed within the operator cabin. The temperature sensor is configured to generate a temperature signal that indicates a current temperature of the operator cabin. The remote system includes a voltage detection sensor coupled to the battery system. The voltage detection sensor is configured to generate a voltage signal that indicates a current voltage of the battery system. The remote system also includes a parking brake sensor configured to generate a parking brake signal that indicates if the parking brake of the work machine is in an applied state. The remote system further includes a controller in communication with each of the at least one door lock sensor, the at least one window lock sensor, the temperature sensor, the voltage detection sensor, and the parking brake sensor. The controller is configured to wirelessly receive, from a user, a user input to turn ON the HVAC system of the work machine. The controller is also configured to determine whether the at least one door of the work machine is open or closed based on the first input signal received from the at least one door lock sensor. The controller is further configured to determine whether the at least one window of the work machine is open or closed based on the second input signal received from the at least one window lock sensor. The controller is configured to determine whether the current temperature of the operator cabin is outside of a desired temperature range based on the temperature signal received from the temperature sensor. The controller is also configured to determine whether the current voltage of the battery system is above a predetermined threshold based on the voltage signal received from the voltage detection sensor. The controller is further configured to determine whether the parking brake of the work machine is in the applied state so as to prevent a movement of the work machine based on the parking brake signal received from the parking brake sensor. The controller is configured to turn ON the power source of the work machine if the at least one door is closed, the at least one window is closed, the current temperature of the operator cabin is outside of the desired temperature range, the current voltage of the battery system is above the predetermined threshold, and the parking brake of the work machine is in the applied state. The controller is also configured to determine if the power source is in an operational state. The controller is further configured to turn ON the HVAC system of the work machine to regulate the current temperature of the operator cabin so as to lie within the desired temperature range if the power source is in the operational state.

Other features and aspects of this disclosure will be apparent from the following description and the accompanying drawings.

### BRIEF DESCRIPTION OF THE DRAWINGS

FIG. 1 is a schematic side view of a work machine, according to an embodiment of the present disclosure;

FIG. 2 is a block diagram of a remote system for regulating a temperature of an operator cabin of the work machine of FIG. 1, according to an embodiment of the present disclosure;

FIGS. 3A and 3B are a flowchart depicting a method for remotely regulating the temperature of the operator cabin of the work machine of FIG. 1, according to an embodiment of the present disclosure;

FIGS. 4A and 4B are a process flowchart for low-level implementation of the method of FIGS. 3A and 3B, according to an embodiment of the present disclosure; and

FIGS. 5A and 5B are a process flowchart for low-level implementation of the method of FIGS. 3A and 3B, according to another embodiment of the present disclosure.

### DETAILED DESCRIPTION

Wherever possible, the same reference numbers will be used throughout the drawings to refer to the same or like parts.

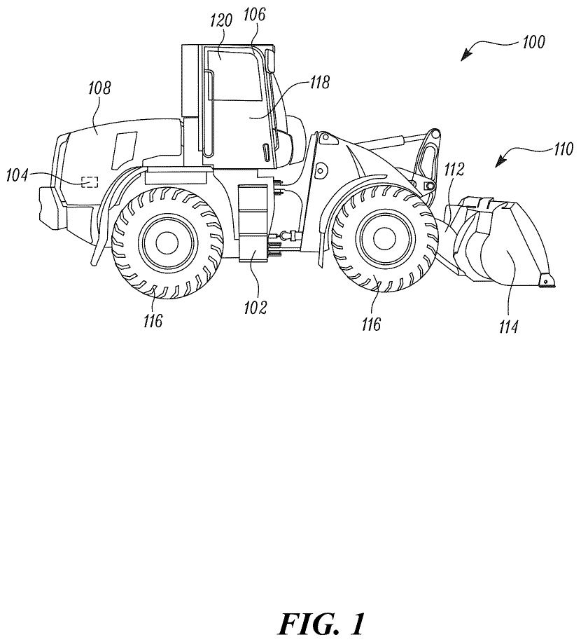

Referring to FIG. 1, a schematic side view of an exemplary work machine 100 is illustrated. The work machine 100 is embodied as a wheel loader that may be used for purposes, such as construction, landscaping, agriculture, and mining. Alternatively, the work machine 100 may be embodied as a truck, an excavator, a tractor, a motor grader, a scraper, or any other work machine known to persons skilled in the art that may be used in various industries.

The work machine 100 includes a frame 102. The work machine 100 also includes a power source 104 mounted on the frame 102. The power source 104 provides an operating power supply to one or more components of the work machine 100, such as a linkage assembly 110 of the work machine 100 and a number of wheels 116 of the work machine 100. The operating power supply from the power source 104 may be used to meet operational and mobility requirements of the work machine 100. The power source 104 may include an engine, such as an internal combustion engine, a battery, a fuel cell, or a combination thereof. The power source 104 is embodied as the engine 104 herein. The power source 104 may be hereinafter interchangeably referred to as “the engine 104”.

The work machine 100 further includes an operator cabin 106 mounted on the frame 102. The operator cabin 106 includes one or more controls (not shown), such as joysticks, brakes, levers, buttons, switches, knobs, audio visual devices, operator consoles, a steering wheel, and the like. The work machine 100 further includes a hood 108 that encloses the power source 104.

The work machine 100 also includes the linkage assembly 110 movably coupled to the frame 102. The linkage assembly 110 includes an arm 112 movably coupled to the frame 102 and an implement 114 movably coupled to the arm 112. The implement 114 is used to perform one or more work operations. The work machine 100 further includes the number of wheels 116. The wheels 116 provide support and mobility to the work machine 100 on grounds.

The work machine 100 includes one or more doors 118 coupled to the operator cabin 106. The work machine 100 may include a single door or two doors. Only one door 118 is illustrated as an example illustrated in FIG. 1. The work machine 100 also includes one or more windows 120 coupled to the operator cabin 106. The work machine 100 may include a single window or two windows. Only one window 120 is illustrated as an example in FIG. 1.

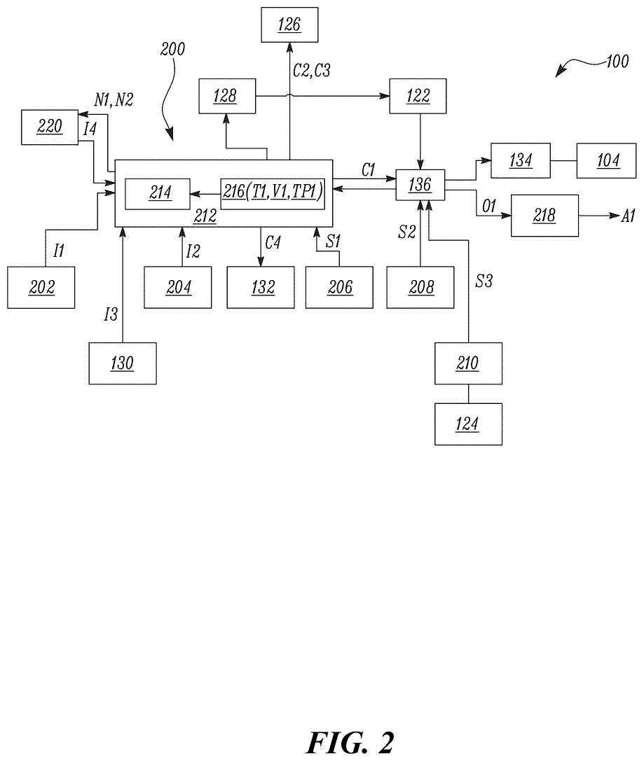

Referring now to FIG. 2, the work machine 100 further includes a battery system 122 to provide an electric power supply to one or more components of the work machine 100. The battery system 122 is a low-voltage battery system. In an example, the battery system 122 may provide a voltage output of 24 Volts. The battery system 122 may provide the electric power supply to a light system of the work machine 100, a machine electronic control module (ECM) 136, or any other machine component. The work machine 100 further includes a parking brake 124. The parking brake 124 is used to prevent a movement of the work machine 100 and to keep the work machine 100 securely motionless when parked. The work machine 100 further includes a heating, ventilation, and air-conditioning (HVAC) system 126 to heat or cool the operator cabin 106 (see FIG. 1). The HVAC system 126 may include various components, such as evaporators, condensers, compressors, and ducts, which operate to either heat or cool the operator cabin 106.

The work machine 100 also includes an ignition relay 128 that starts the battery system 122. The work machine 100 further includes a key position relay 130 associated with the door 118 (see FIG. 1) of the operator cabin 106. The key position relay 130 may indicate if the door 118 of the operator cabin 106 has been opened using a machine key.

Further, the work machine 100 includes a fuel shut-off valve 132 that supplies fuel to the engine 104, and a starter motor 134 that starts the engine 104. The work machine 100 also includes the machine ECM 136. The machine ECM 136 is in communication with the starter motor 134 and the battery system 122.

The present disclosure relates to a remote system 200 for regulating a temperature of the operator cabin 106 of the work machine 100. The work machine 100 includes the remote system 200. In an example, the remote system 200 may be retrofitted on the work machine 100. The remote system 200 includes one or more door lock sensors 202 coupled to the one or more doors 118 of the work machine 100. The one or more door lock sensors 202 generate a first input signal I1 that indicates if the one or more doors 118 are open or closed.

The remote system 200 also includes one or more window lock sensors 204 coupled to the one or more windows 120 (see FIG. 1) of the work machine 100. The one or more window lock sensors 204 generate a second input signal I2 that indicates if the one or more windows 120 are open or closed.

The door lock sensor 202 may include any type of sensor that may detect if the doors 118 are open or closed and may also detect if the door 118 has been broken to gain unauthorized access to the operator cabin 106. Similarly, the window lock sensor 204 may include any type of sensor that may detect if the windows 120 are open or closed and may also detect if the window 120 has been broken to gain unauthorized access to the operator cabin 106. In some examples, each of the one or more door lock sensors 202 and the one or more window lock sensors 204 includes a pressure sensor, a capacitive sensor, a load sensor, a force sensor, or a touch sensor. In an example, the door lock sensor 202 may include a pressure sensor. In an example, the window lock sensor 204 may include a capacitive sensor. It should be noted that the present disclosure is not limited by a type of the door lock sensor 202 and the window lock sensor 204, and the door lock sensor 202 and the window lock sensor 204 may include any type of sensor known to persons skilled in the art.

The remote system 200 further includes a temperature sensor 206 disposed within the operator cabin 106. The temperature sensor 206 generates a temperature signal S1 that indicates a current temperature of the operator cabin 106. The temperature sensor 206 may include any type of sensor known to persons skilled in the art that generates information related to a temperature of a surrounding in which the sensor is mounted. The temperature sensor 206 may include, for example, a thermistor, a thermocouple, a resistance temperature detector, a fiber optic sensor, a radiation thermometer, or an optical pyrometer.

The remote system 200 further includes a voltage detection sensor 208 coupled to the battery system 122 of the work machine 100. The voltage detection sensor 208 generates a voltage signal S2 that indicates a current voltage of the battery system 122. The voltage detection sensor 208 may include a resistive voltage sensor, a capacitive voltage sensor, an inductive voltage sensor, or any other sensor known to persons skilled in the art.

The remote system 200 also includes a parking brake sensor 210 coupled to the work machine 100. The parking brake sensor 210 generates a parking brake signal S3 that indicates if the parking brake 124 of the work machine 100 is in an applied state. In one example, the parking brake sensor 210 may include a position sensor that monitors the parking brake 124 and generates information to indicate a position of the parking brake 124. Alternatively, the parking brake sensor 210 may include any other type of sensor known to persons skilled in the art that indicates if the parking brake 124 of the work machine 100 is in an applied state or not.

The remote system 200 further includes a controller 212 in communication with each of the one or more door lock sensors 202, the one or more window lock sensors 204, the temperature sensor 206, the voltage detection sensor 208, and the parking brake sensor 210. The controller 212 is also in communication with the machine ECM 136, the key position relay 130, the ignition relay 128, and the fuel shut-off valve 132. In some examples, functions of the controller 212 may be implemented by the machine ECM 136. In other words, functionalities of the controller 212 and the machine ECM 136 may be implemented by a single control module. Further, the voltage detection sensor 208 and the parking brake sensor 210 are in communication with the controller 212 via the machine ECM 136. In other words, information from each of the voltage detection sensor 208 and the parking brake sensor 210 is received by the machine ECM 136, and the machine ECM 136 transmits the information to the controller 212.

The controller 212 includes one or more memories 214. The memories 214 may include any means of storing information, including a hard disk, an optical disk, a floppy disk, ROM (read only memory), RAM (random access memory), PROM (programmable ROM), EEPROM (electrically erasable PROM), or other computer-readable memory media known to persons skilled in the art. The memories 214 may store various information therein. For example, the memories 214 may store a desired temperature range T1 that is to be maintained within the operator cabin 106. The desired temperature range T1 may be variable and may depend on, for example, a user or an ambient temperature at a location where the work machine 100 is operating. The user may include an operator of the work machine 100. The desired temperature range T1 is an optimal temperature range at which the operator can be comfortably seated within the operator cabin 106 and perform work operations. Further, the memories 214 may also store a predetermined threshold V1 for the battery system 122. The predetermined threshold V1 is a threshold value below which the battery system 122 may not operate efficiently or may not operate at all.

The controller 212 also includes one or more processors 216 communicably coupled to the one or more memories 214. It should be noted that the one or more processors 216 may embody a single microprocessor or multiple microprocessors for receiving various input signals and generating output signals. Numerous commercially available microprocessors may perform the functions of the one or more processors 216. Each processor 216 may include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor 216 may include one or more components that may be operable to execute computer executable instructions or computer code that may be stored and retrieved from the one or more memories 214.

The remote system 200 also includes an indication module 218 in communication with the controller 212. The indication module 218 is disposed externally relative to the operator cabin 106. For example, the indication module 218 may be mounted on an outer side of the operator cabin 106 or on the frame 102 (see FIG. 1) of the work machine 100. The indication module 218 may include a speaker, a light such as a strobe light, or any other output device known to persons skilled in the art. In the illustrated example of FIG. 2, the indication module 218 is in communication with the controller 212 via the machine ECM 136.

The controller 212 wirelessly receives, from the user, a user input I4 to turn ON the HVAC system 126 of the work machine 100. The user is present at an external location relative to the work machine 100. The controller 212 receives the user input I4 from a user device 220 present with the user. The user device 220 may be wirelessly connected with the controller 212, for example, via Bluetooth, WIFI, or any other means of wireless communication known to persons skilled in the art.

The user device 220 includes a handheld electronic device or a remote-control key. For example, the user device 220 may include a smartphone, a tablet, or any other Input/Output device known to persons skilled in the art. In an example, the handheld electronic device may include a software application through which the user may send the user input I4 to the controller 212. In another example, the user may access a web page on the handheld electronic device to send the user input I4 to the controller 212. Further, the remote-control key may include any type of Input/Output device known to persons skilled in the art that may be in wireless communication with the controller 212 to send/receive data. It should be noted that the present disclosure is not limited by a technique or a device using which the user sends the user input I4 to the controller 212 or receives data from the controller 212.

The controller 212 determines whether the one or more doors 118 of the work machine 100 are open or closed based on the first input signal I1 received from the one or more door lock sensors 202. The controller 212 also determines whether the one or more windows 120 of the work machine 100 are open or closed based on the second input signal I2 received from the one or more window lock sensors 204. The controller 212 further determines whether the current temperature of the operator cabin 106 is outside of the desired temperature range T1 based on the temperature signal S1 received from the temperature sensor 206. Further, if the doors 118 and the windows 120 of the operator cabin 106 are closed and the current temperature of the operator cabin 106 is outside of the desired temperature range T1, the controller 212 starts the battery system 122 via the ignition relay 128.

The controller 212 determines whether the current voltage of the battery system 122 is above the predetermined threshold V1 based on the voltage signal S2 received from the voltage detection sensor 208. The machine ECM 136 is in communication with the battery system 122 and the voltage detection sensor 208. Further, the machine ECM 136 receives the voltage signal S2 that indicates the current voltage of the battery system 122 from the voltage detection sensor 208. Furthermore, the machine ECM 136 transmits the voltage signal S2 to the controller 212 based on which the controller 212 determines if the current voltage of the battery system 122 is above or below the predetermined threshold V1.

The controller 212 also determines whether the parking brake 124 of the work machine 100 is in the applied state so as to prevent a movement of the work machine 100 based on the parking brake signal S3 received from the parking brake sensor 210. The machine ECM 136 is in communication with the parking brake sensor 210. Further, the machine ECM 136 receives the parking brake signal S3 from the parking brake sensor 210. Furthermore, the machine ECM 136 transmits the parking brake signal S3 to the controller 212 based on which the controller 212 determines if the parking brake 124 of the work machine 100 is in the applied state or not.

Further, the controller 212 turns ON the power source 104 of the work machine 100 if the one or more doors 118 are closed, the one or more windows 120 are closed, the current temperature of the operator cabin 106 is outside of the desired temperature range T1, the current voltage of the battery system 122 is above the predetermined threshold V1, and the parking brake 124 of the work machine 100 is in the applied state. The controller 212 generates a first control signal C1 to turn ON the power source 104. The first control signal C1 is transmitted to the machine ECM 136. Based on receipt of the first control signal C1, the machine ECM 136 starts the starter motor 134 which in turn causes the engine 104 to turn ON.

Further, the controller 212 transmits an output signal O1 to the indication module 218 before the power source 104 is turned ON. The controller 212 transmits the output signal O1 to the machine ECM 136 which in turn transmits the output signal O1 to the indication module 218. Alternatively, the indication module 218 may be in direct communication with the controller 212. Further, based on the output signal O1 received from the controller 212, the indication module 218 generates an alert A1 before the power source 104 is turned ON. The alert A1 notifies personnel present around the work machine 100 that the power source 104 is going to start. In an example, the alert A1 may be a visual notification, such as, a strobe light. In another example, the alert A1 may be an audio notification, such as, a voice message, an alarm, a buzzer, and so on, or an audiovisual notification.

The controller 212 also determines if the power source 104 is in an operational state. In an example, the machine ECM 136 determines if the engine 104 is in the operational state. The machine ECM 136 may determine whether the engine 104 is operating based on receipt of input signals from one or more sensors (not shown) associated with the engine 104. For example, the machine ECM 136 may monitor parameters, such as engine revolutions, engine load, manifold pressure, coolant temperature, fuel system status, or any other parameter known to persons skilled in the art to determine if the engine 104 is in the operational state. Further, the machine ECM 136 transmits information related to the operational state of the engine 104 to the controller 212, based on which the controller 212 determines that the power source 104 is in the operational state.

Further, the controller 212 turns ON the HVAC system 126 of the work machine 100 to regulate the current temperature of the operator cabin 106 so as to lie within the desired temperature range T1 if the power source 104 is in the operational state. The controller 212 generates a second control signal C2 to turn ON the HVAC system 126. The second control signal C2 is directly transmitted to the HVAC system 126. Based on receipt of the second control signal C2, the HVAC system 126 starts operating to regulate the temperature of the operator cabin 106 so as to lie within the desired temperature range T1. In some examples, the controller 212 also determines a fuel level in a fuel tank of the work machine 100, before generating the output signal O1 and the first control signal C1. The controller 212 may be in communication with a fuel level sensor (not shown) to determine if the fuel level in the fuel tank is sufficient to operate the engine 104 and the HVAC system 126. If the fuel level in the fuel tank is sufficient to operate the engine 104 and the HVAC system 126, the controller 212 generates the output signal O1 and the first control signal C1. In an embodiment, the controller 212 determines whether the one or more doors 118 are open based on the first input signal I1 received from the one or more door lock sensors 202, the one or more windows 120 are open based on the second input signal I2 received from the one or more window lock sensors 204, the current temperature of the operator cabin 106 is within the desired temperature range T1 based on the temperature signal S1 received from the temperature sensor 206, the current voltage of the battery system 122 is below the predetermined threshold V1 based on the voltage signal S2 received from the voltage detection sensor 208, and/or the parking brake 124 of the work machine 100 is not in the applied state based on the parking brake signal S3 received from the parking brake sensor 210.

In such an embodiment, the controller 212 does not take any action, i.e., the controller 212 does not turn ON the power source 104 or the HVAC system 126 if the controller 212 determines that the one or more doors 118 are open, the one or more windows 120 are open, the current temperature of the operator cabin 106 is within the desired temperature range T1, the current voltage of the battery system 122 is below the predetermined threshold V1, and/or the parking brake 124 of the work machine 100 is not in the applied state. Further, if the fuel level in the fuel tank is not sufficient to operate the engine 104 and the HVAC system 126, the controller 212 does not turn ON the power source 104 or the HVAC system 126.

Moreover, the controller 212 transmits a notification N2 to the user device 220 to indicate that the power source 104 has not been turned ON if the one or more doors 118 are open, the one or more windows 120 are open, the current temperature of the operator cabin 106 is within the desired temperature range T1, the current voltage of the battery system 122 is below the predetermined threshold V1, and/or the parking brake 124 of the work machine 100 is not in the applied state. Further, the controller 212 also transmits the transmits the notification N2 if the fuel level in the fuel tank is not sufficient to operate the engine 104 and the HVAC system 126.

In an embodiment, the controller 212 keeps monitoring the current temperature of the operator cabin 106 after turning ON the HVAC system 126. The controller 212 determines whether the current temperature of the operator cabin 106 is within the desired temperature range T1 based on the temperature signal S1 received from the temperature sensor 206. Further, the controller 212 turns OFF the HVAC system 126 if each of the current temperature of the operator cabin 106 is within the desired temperature range T1 and a predefined time period TP1 has elapsed from turning ON of the HVAC system 126. The controller 212 generates a third control signal C3 to turn OFF the HVAC system 126. The third control signal C3 is directly transmitted to the HVAC system 126 to turn OFF the HVAC system 126.

The term “predefined time period TP1” as used herein refers to a time duration for which the HVAC system 126 and the power source 104 are ON after the controller 212 turns ON the HVAC system 126. The memories 214 may store information related to the predefined time period TP1 therein.

Moreover, the controller 212 turns OFF the power source 104 if each the current temperature of the operator cabin 106 is within the desired temperature range T1 and the predefined time period TP1 has elapsed from turning ON of the HVAC system 126. The controller 212 generates a fourth control signal C4 to turn OFF the power source 104. The controller 212 transmits the fourth control signal C4 to the fuel shut-off valve 132. Based on receipt of the fourth control signal C4, the fuel shut-off valve 132 cuts off the supply of fuel to the engine 104 to turn OFF the engine 104. Thus, the HVAC system 126 and the engine 104 operate only until the elapse of the predefined time period TP1, after which the HVAC system 126 and the engine 104 are turned OFF. In an example, the controller 212 also transmits a notification N1 to the user device 220 prior to the elapse of the predefined time period TP1. The notification N1 may indicate to the user that the HVAC system 126 and the engine 104 will be turned OFF in, for example 1 minute, 2 minutes, or 5 minutes.

In an embodiment, the controller 212 keeps monitoring the first and second input signals I1, I2 received from the door lock sensor 202 and the window lock sensor 204, respectively, after turning ON the HVAC system 126 to determine if the user has entered the operator cabin 106 before the elapse of the predefined time period TP1. In such an embodiment, the controller 212 determines whether the one or more doors 118 of the work machine 100 are open based on the first input signal I1 received from the one or more door lock sensors 202 and/or the one or more windows 120 of the work machine 100 are open based on the second input signal I2 received from the one or more window lock sensors 204, while each of the power source 104 and the HVAC system 126 is ON. The controller 212 further determines whether the current temperature of the operator cabin 106 is outside the desired temperature range T1 based on the temperature signal S1 received from the temperature sensor 206. In such an embodiment, the controller 212 also determines whether the operator cabin 106 was accessed by the user using the machine key. The controller 212 determines if the operator cabin 106 was accessed by the user based on an input signal I3 received from the key position relay 130.

Further, the controller 212 turns OFF the HVAC system 126 if the one or more doors 118 of the work machine 100 are open and/or the one or more windows 120 of the work machine 100 are open even if the current temperature of the operator cabin 106 is outside the desired temperature range T1. Furthermore, the controller 212 turns OFF the power source 104 if the one or more doors 118 of the work machine 100 are open and/or the one or more windows 120 of the work machine 100 are open even if the current temperature of the operator cabin 106 is outside the desired temperature range T1. Thus, the HVAC system 126 and the engine 104 operate only when the doors 118 and the windows 120 are closed, and the controller 212 turns OFF each of the HVAC system 126 and the engine 104 if the door 118 or the window 120 are open.

Further, in an embodiment, the controller 212 also determines an entry of an unauthorized user into the operator cabin 106 by breaking the door 118 or the window 120. The controller 212 determines the entry of the unauthorized user based on the first or second input signals I1, I2 from the door lock sensor 202 or the window lock sensor 204, and the input signal I3 from the key position relay 130. The controller 212 determines the entry of the unauthorized user if the door 118 or the window 120 of the operator cabin 106 are open and the key position relay 130 does not indicate that the machine key was used to access the operator cabin 106. In such cases, the controller 212 turns OFF the engine 104 and the HVAC system 126 to prevent unauthorized access to the work machine 100. In some examples, the controller 212 may also generate an alarm, using the indication module 218, to indicate that the work machine 100 was accessed by an unauthorized user.

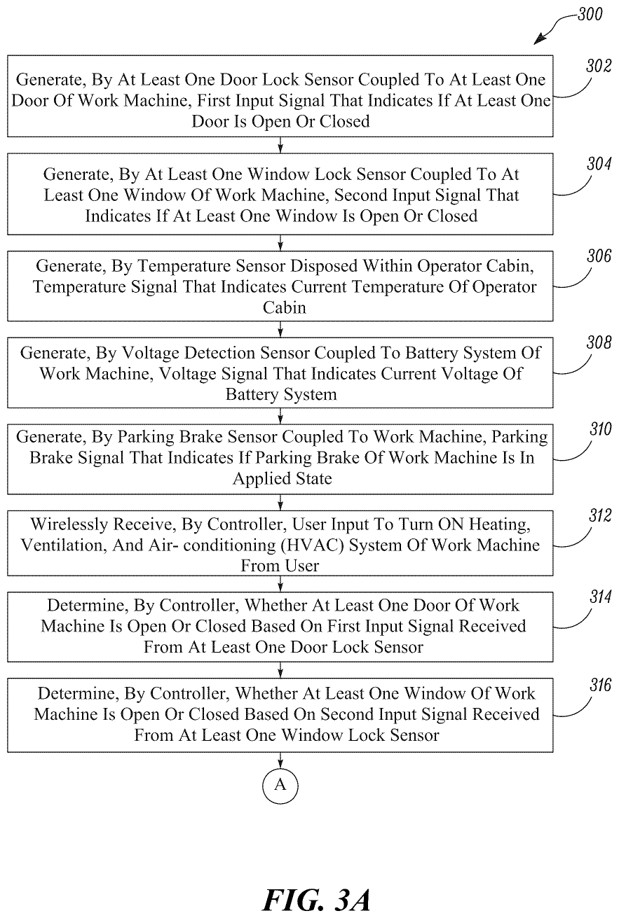

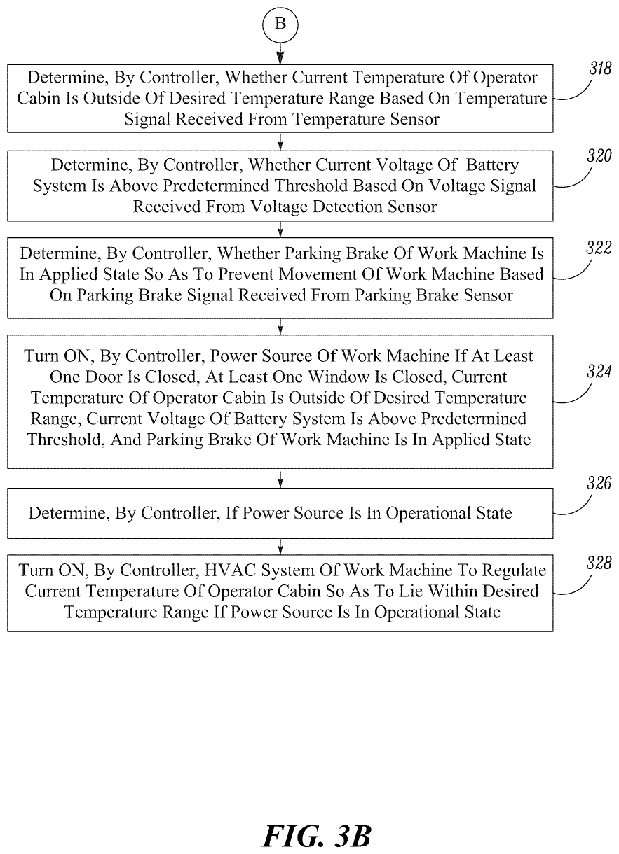

Referring to FIGS. 3A and 3B, a flowchart for a method 300 for remotely regulating the temperature of the operator cabin 106 of the work machine 100 is illustrated. At step 302, the one or more door lock sensors 202 coupled to the one or more doors 118 of the work machine 100 generate the first input signal I1 that indicates if the one or more doors 118 are open or closed. At step 304, the one or more window lock sensors 204 coupled to the one or more windows 120 of the work machine 100 generate the second input signal I2 that indicates if the one or more windows 120 are open or closed. At step 306, the temperature sensor 206 disposed within the operator cabin 106 generates the temperature signal S1 that indicates the current temperature of the operator cabin 106. At step 308, the voltage detection sensor 208 coupled to the battery system 122 of the work machine 100 generates the voltage signal S2 that indicates the current voltage of the battery system 122. At step 308, the parking brake sensor 210 coupled to the work machine 100 generates the parking brake signal S3 that indicates if the status of the parking brake 124 of the work machine 100 is in the applied state.

At step 310, the controller 212 wirelessly receives the user input I4 to turn ON the HVAC system 126 of the work machine 100 from the user. The controller 212 is in communication with each of the one or more door lock sensors 202, the one or more window lock sensors 204, the temperature sensor 206, the voltage detection sensor 208, and the parking brake sensor 210.

At step 312, the controller 212 determines whether the one or more doors 118 of the work machine 100 are open or closed based on the first input signal I1 received from the one or more door lock sensors 202. At step 314, the controller 212 determines whether the one or more windows 120 of the work machine 100 are open or closed based on the second input signal I2 received from the one or more window lock sensors 204. At step 316, the controller 212 determines whether the current temperature of the operator cabin 106 is outside of the desired temperature range T1 based on the temperature signal S1 received from the temperature sensor 206.

At step 318, the controller 212 determines whether the current voltage of the battery system 122 is above the predetermined threshold V1 based on the voltage signal S2 received from the voltage detection sensor 208. At step 320, the controller 212 determines whether the parking brake 124 of the work machine 100 is in the applied state so as to prevent the movement of the work machine 100 based on the parking brake signal S3 received from the parking brake sensor 210.

At step 322, the controller 212 turns ON the power source 104 of the work machine 100 if the one or more doors 118 are closed, the one or more windows 120 are closed, the current temperature of the operator cabin 106 is outside of the desired temperature range T1, the current voltage of the battery system 122 is above the predetermined threshold V1, and the parking brake 124 of the work machine 100 is in the applied state. At step 324, the controller 212 determines if the power source 104 is in the operational state. At step 326, the controller 212 turns ON the HVAC system 126 of the work machine 100 to regulate the current temperature of the operator cabin 106 so as to lie within the desired temperature range T1 if the power source 104 is in the operational state.

Further, the method 300 includes a step at which the controller 212 transmits the output signal O1 to the indication module 218 before turning ON the power source 104. The indication module 218 is in communication with the controller 212. The indication module 218 is disposed externally relative to the operator cabin 106. The method 300 further includes a step at which the indication module 218 generates the alert A1 before the power source 104 of the work machine 100 is turned ON based on the output signal O1 received from the controller 212.

The method 300 further includes a step at which the controller 212 determines whether the current temperature of the operator cabin 106 is within the desired temperature range T1 based on the temperature signal S1 received from the temperature sensor 206. The method 300 further includes a step at which the controller 212 turns OFF the HVAC system 126 if each of the current temperature of the operator cabin 106 is within the desired temperature range T1 and the predefined time period TP1 has elapsed from the turning ON of the HVAC system 126. The method 300 further includes a step at which the controller 212 turns OFF the power source 104 if each of the current temperature of the operator cabin 106 is within the desired temperature range T1 and the predefined time period TP1 has elapsed from the turning ON of the HVAC system 126.

The method 300 further includes a step at which the controller 212 determines whether the one or more doors 118 of the work machine 100 are open based on the first input signal I1 received from the one or more door lock sensors 202 and/or the one or more windows 120 of the work machine 100 are open based on the second input signal I2 received from the one or more window lock sensors 204, while each of the power source 104 and the HVAC system 126 is ON. The method 300 further includes a step at which the controller 212 determines whether the current temperature of the operator cabin 106 is outside the desired temperature range T1 based on the temperature signal S1 received from the temperature sensor 206. The method 300 further includes a step at which the controller 212 turns OFF the HVAC system 126 if the one or more doors 118 of the work machine 100 are open and/or the one or more windows 120 of the work machine 100 are open even if the current temperature of the operator cabin 106 is outside the desired temperature range T1. The method 300 further includes a step at which the controller 212 turns OFF the power source 104 if the one or more doors 118 of the work machine 100 are open and/or the one or more windows 120 of the work machine 100 are open even if the current temperature of the operator cabin 106 is outside the desired temperature range T1.

The method 300 further includes a step at which the controller 212 determines whether the one or more doors 118 are open based on the first input signal I1 received from the one or more door lock sensors 202, the one or more windows 120 are open based on the second input signal I2 received from the one or more window lock sensors 204, the current temperature of the operator cabin 106 is within the desired temperature range T1 based on the temperature signal S1 received from the temperature sensor 206, the current voltage of the battery system 122 is below the predetermined threshold V1 based on the voltage signal S2 received from the voltage detection sensor 208, and/or the parking brake 124 of the work machine 100 is not in the applied state based on the parking brake signal S3 received from the parking brake sensor 210. The method 300 further includes a step at which the controller 212 transmits the notification N2 to the user device 220 that the power source 104 has not been turned ON if the one or more doors 118 are open, the one or more windows 120 are open, the current temperature of the operator cabin 106 is within the desired temperature range T1, the current voltage of the battery system 122 is below the predetermined threshold V1, and/or the parking brake 124 of the work machine 100 is not in the applied state.

The method 300 further includes a step at which the controller 212 wirelessly receives the user input I4 from the user device 220 present with the user. The user device 220 includes the handheld electronic device or the remote-control key.

It should be noted that one or more of the steps shown in FIGS. 3A and 3B, and/or described above, may be performed in an order different from that depicted and/or described. Furthermore, various steps could be performed together.

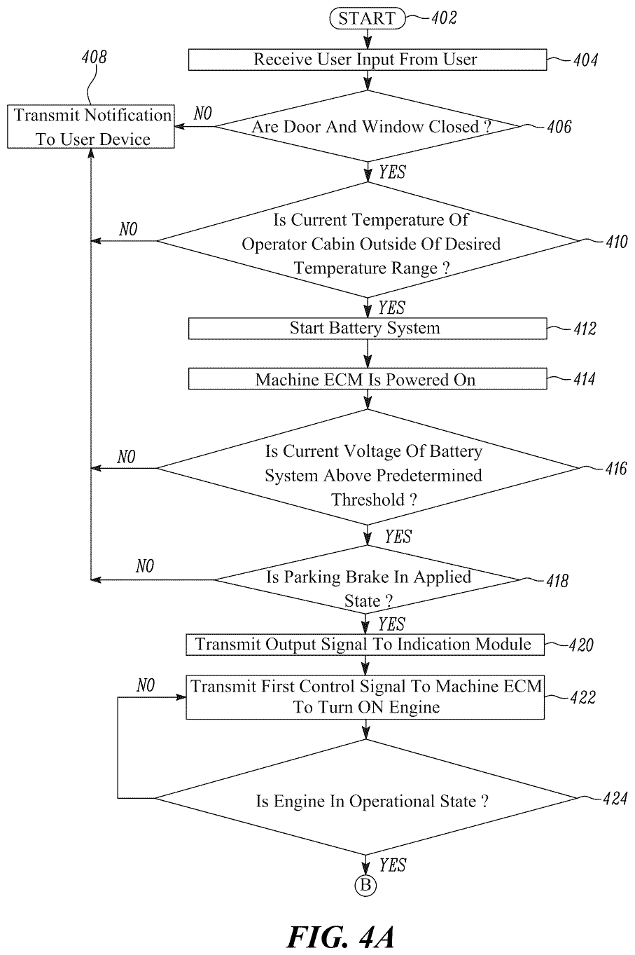

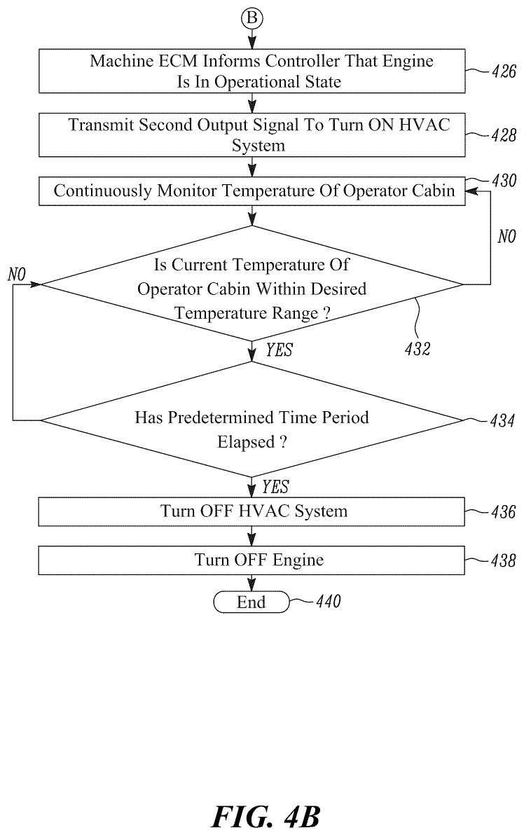

FIGS. 4A and 4B are a flowchart for a process 400 for remotely regulating the temperature of the operator cabin 106 of the work machine 100. The process 400 is a low-level implementation of the method 300 explained in relation to FIGS. 3A and 3B. Referring to FIGS. 2, 4A, and 4B, the process 400 may be stored in the memories 214 of the controller 212 and retrieved for execution by the processors 216 of the controller 212.

At a block 402, the process 400 starts operation. At a block 404, the controller 212 wirelessly receives the user input I4 from the user. At a block 406, the controller 212 determines if the doors 118 and the windows 120 are closed, based on the first and second input signals I1, I2 received from the door lock sensors 202 and the window lock sensors 204, respectively. At the block 406, if the controller 212 determines that the doors 118 and the windows 120 are open, the controller 212 moves to a block 408 at which the controller 212 transmits the notification N2 to the user device 220 that the engine 104 and the HVAC system 126 will not be turned ON as the doors 118 and/or the windows 120 are open. However, at the block 406, if the controller 212 determines that the door 118 and the window 120 are closed, the process 400 moves to a block 410.

At the block 410, the controller 212 determines if the current temperature of the operator cabin 106 is outside the desired temperature range T1. At the block 410, if the controller 212 determines that the current temperature of the operator cabin 106 is within the desired temperature range T1, the controller 212 moves to the block 408 at which the controller 212 transmits the notification N2 to the user device 220 that the engine 104 and the HVAC system 126 will not be turned ON as the current temperature of the operator cabin 106 is within the desired temperature range T1. However, at the block 410, if the controller 212 determines that the current temperature of the operator cabin 106 is outside the desired temperature range T1, the process 400 moves to a block 412.

At the block 412, the controller 212 starts the battery system 122 via the ignition relay 128. The process 400 then moves to a block 414 at which the machine ECM 136 is powered on. The process 400 then moves to a block 416 at which the controller 212 determines if the current voltage of the battery system 122 is above the predetermined threshold V1. At the block 416, if the controller 212 determines that the current voltage of the battery system 122 is below the predetermined threshold V1, the controller 212 moves to the block 408 at which the controller 212 transmits the notification N2 to the user device 220 that the engine 104 and the HVAC system 126 will not be turned ON as the current voltage of the battery system 122 is below the predetermined threshold V1. However, at the block 416, if the controller 212 determines that the current voltage of the battery system 122 is above the predetermined threshold V1, the process 400 moves to a block 418.

At the block 418, the controller 212 determines if the parking brake 124 of the work machine 100 is in the applied state. At the block 418, if the controller 212 determines that the parking brake 124 of the work machine 100 is not in the applied state, the controller 212 moves to the block 408 at which the controller 212 transmits the notification N2 to the user device 220 that the engine 104 and the HVAC system 126 will not be turned ON as the parking brake 124 is not in the applied state. However, at the block 418, if the controller 212 determines that the parking brake 124 of the work machine 100 is in the applied state, the process 400 moves to a block 420.

At the block 420, the controller 212 transmits the output signal O1 to the indication module 218 via the machine ECM 136 to indicate to personnel present around the work machine 100 that the engine 104 is about to start. From the block 420, the process 400 moves to a block 422 at which the controller 212 transmits the first control signal C1 to the machine ECM 136 to start the starter motor 134 in order to turn ON the engine 104. Based on receipt of the first control signal C1, the machine ECM 136 starts the starter motor 134 which in turn causes the engine 104 to turn ON. From the block 422, the process 400 moves to a block 424 at which the machine ECM 136 determines if the engine 104 is in the operational state. At the block 424, if the machine ECM 136 determines that the engine 104 is not in the operational state, the process 400 moves back to the block 422. However, at the block 424, if the machine ECM 136 determines that the engine 104 is in the operational state, the process 400 moves to a block 426. At the block 426, the machine ECM 136 informs the controller 212 that the engine 104 is in the operational state.

The process 400 then moves to a block 428 at which the controller 212 transmits the second control signal C2 to the HVAC system 126 to turn ON the HVAC system 126. The process 400 then moves to a block 430 at which the controller 212 continuously monitors the current temperature of the operator cabin 106 based on the temperature signal S1 received from the temperature sensor 206. The process 400 then moves to a block 432 at which the controller 212 compares the current temperature of the operator cabin 106 with the desired temperature range T1. At the block 432, if the controller 212 determines that the current temperature of the operator cabin 106 is outside the desired temperature range T1, the process 400 moves back to the block 430. However, at the block 432, if the controller 212 determines that the current temperature of the operator cabin 106 is within the desired temperature range T1, the process 400 moves to a block 434. At the block 434, the controller 212 determines if the predefined time period TP1 has elapsed. If the controller 212 determines that the predefined time period TP1 has not elapsed, the process 400 moves back to the block 432. However, if the controller 212 determines that the predefined time period TP1 has elapsed, the process 400 moves to a block 436 at which the controller 212 turns OFF the HVAC system 126. The process 400 then moves to a block 438 at which the controller 212 turns OFF the engine 104 using the fuel shut-off valve 132. The process 400 then moves to a block 440 at which the process 400 ends operation.

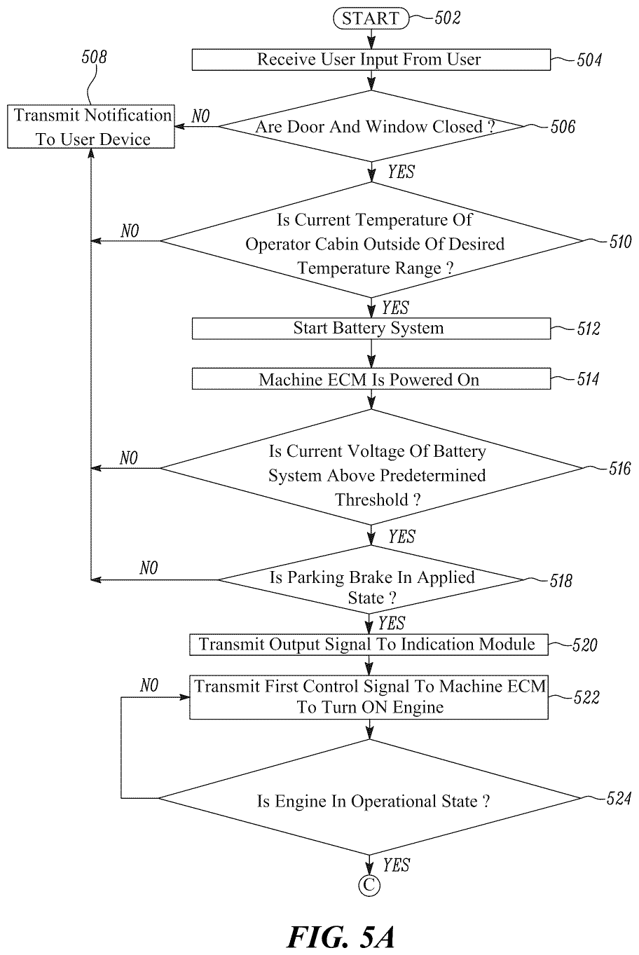

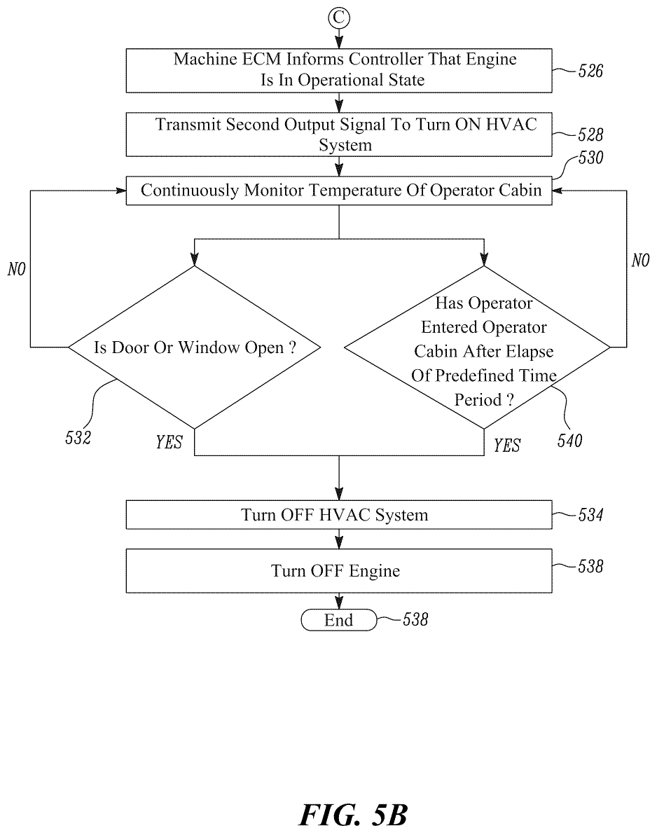

FIGS. 5A and 5B are a flowchart for a process 500 for remotely regulating the temperature of the operator cabin 106 of the work machine 100. The process 500 is a low-level implementation of the method 300 explained in relation to FIGS. 3A and 3B. Referring to FIGS. 2, 5A, and 5B, the process 500 may be stored in the memories 214 of the controller 212 and retrieved for execution by the processors 216 of the controller 212.

At a block 502, the process 500 starts operation. At a block 504, the controller 212 wirelessly receives the user input I4 from the user. At a block 506, the controller 212 determines if the doors 118 and the windows 120 are closed, based on the first and second input signals I1, I2 received from the door lock sensors 202 and the window lock sensors 204, respectively. At the block 506, if the controller 212 determines that the doors 118 and the windows 120 are open, the controller 212 moves to a block 508 at which the controller 212 transmits the notification N2 to the user device 220 that the engine 104 and the HVAC system 126 will not be turned ON as the doors 118 and/or the windows 120 are open. However, at the block 506, if the controller 212 determines that the doors 118 and the windows 120 are closed, the process 500 moves to a block 510.

At the block 510, the controller 212 determines if the current temperature of the operator cabin 106 is outside the desired temperature range T1. At the block 510, if the controller 212 determines that the current temperature of the operator cabin 106 is within the desired temperature range T1, the controller 212 moves to the block 508 at which the controller 212 transmits the notification N2 to the user device 220 that the engine 104 and the HVAC system 126 will not be turned ON as the current temperature of the operator cabin 106 is within the desired temperature range T1. However, at the block 510, if the controller 212 determines that the current temperature of the operator cabin 106 is outside the desired temperature range T1, the process 500 moves to a block 512.

At the block 512, the controller 212 starts the battery system 122 via the ignition relay 128. The process 500 then moves to a block 514 at which the machine ECM 136 is powered on. The process 500 then moves to a block 516 at which the controller 212 determines if the current voltage of the battery system 122 is above the predetermined threshold V1. At the block 516, if the controller 212 determines that the current voltage of the battery system 122 is below the predetermined threshold V1, the controller 212 moves to the block 508 at which the controller 212 transmits the notification N2 to the user device 220 that the engine 104 and the HVAC system 126 will not be turned ON as the current voltage of the battery system 122 is below the predetermined threshold V1. However, at the block 516, if the controller 212 determines that the current voltage of the battery system 122 is above the predetermined threshold V1, the process 500 moves to a block 518.

At the block 518, the controller 212 determines if the parking brake 124 of the work machine 100 is in the applied state. At the block 518, if the controller 212 determines that the parking brake 124 of the work machine 100 is not in the applied state, the controller 212 moves to the block 508 at which the controller 212 transmits the notification N2 to the user device 220 that the engine 104 and the HVAC system 126 will not be turned ON as the parking brake 124 is not in the applied state. However, at the block 518, if the controller 212 determines that the parking brake 124 of the work machine 100 is in the applied state, the process 500 moves to a block 520.

At the block 520, the controller 212 transmits the output signal O1 to the indication module 218 via the machine ECM 136 to indicate to personnel present around the work machine 100 that the engine 104 is about to start. From the block 520, the process 500 moves to a block 522 at which the controller 212 transmits the first control signal C1 to the machine ECM 136 to turn ON the starter motor 134 in order to turn ON the engine 104. Based on receipt of the first control signal C1, the machine ECM 136 starts the starter motor 134 which in turn causes the engine 104 to turn ON. From the block 522, the process 500 moves to a block 524 at which the machine ECM 136 determines if the engine 104 is in the operational state. At the block 524, if the machine ECM 136 determines that the engine 104 is not in the operational state, the process 500 moves back to the block 522. However, at the block 524, if the machine ECM 136 determines that the engine 104 is in the operational state, the process 500 moves to a block 526. At the block 526, the machine ECM 136 informs the controller 212 that the engine 104 is in the operational state.

The process 500 then moves to a block 528 at which the controller 212 transmits the second control signal C2 to the HVAC system 126 to turn ON the HVAC system 126. The process 500 then moves to a block 530 at which the controller 212 continuously monitors the current temperature of the operator cabin 106 based on the temperature signal S1 received from the temperature sensor 206.

From the block 530, the process 500 may move to a block 532 at which the controller 212 determines if the door 118 or the window 120 of the operator cabin 106 are open based on the first and second input signals I1, I2 received from the door lock sensor 202 and the window lock sensor 204, respectively. At the block 532, the controller 212 also determines if the door 118 of the operator cabin 106 was opened using the machine key based on the input signal I3 received from the key position relay 130. If the controller 212 determines that the door 118 or the window 120 of the operator cabin 106 are open or the door 118 of the operator cabin 106 was opened using the machine key, the process 500 moves to a block 534 at which the controller 212 turns OFF the HVAC system 126. The process 500 then moves to a block 536 at which the controller 212 turns OFF the engine 104 using the fuel shut-off valve 132. The process 500 then moves to a block 538, at which the process 500 ends operation. In this scenario, the operator enters the operator cabin 106 before the elapse of the predefined time period TP1. It should be noted that the engine 104 and the HVAC system 126 are turned OFF to maintain optimal machine start conditions.

From the block 530, the process 500 may also move to a block 540 at which the controller 212 determines that the operator entered the operator cabin 106 after the elapse of the predefined time period TP1. If the controller 212 determines that the operator has not entered the operator cabin 106 even after the elapse of the predefined time period TP1, the process 500 moves to the block 534 at which the controller 212 turns OFF the HVAC system 126. The process 500 then moves to the block 536 at which the controller 212 turns OFF the engine 104 using the fuel shut-off valve 132. It should be noted that the engine 104 and the HVAC system 126 are turned OFF to conserve fuel and battery power of the battery system 122. The process 500 then moves to the block 538, at which the process 500 ends operation.

It may be noted that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure as defined in the appended claims.

### Industrial Applicability

The present disclosure describes the remote system 200 and the method 300 for regulating the temperature of the operator cabin 106 of the work machine 100. The remote system 200 and the method 300 may eliminate a requirement for operators to physically enter the operator cabin 106 to turn ON the engine 104 and the HVAC system 126 to cool or warm the operator cabin 106, which may improve operator convenience. Further, the remote system 200 and the method 300 ensures that the current temperature of the operator cabin 106 is within the desired temperature range T1, which may improve operator comfort and operator productivity. Further, as the remote system 200 and the method 300 also turns ON the engine 104, the work machine 100 is in a ready to operate state when the operator enters the operator cabin 106 of the work machine 100. This feature of heating the engine 104 may be advantageous in extreme cold environments, where cold cranking is necessary.

The remote system 200 may be retrofitted on exiting work machines to enable users to turn ON the engine 104 and the HVAC system 126 remotely. The remote system 200 may be cost-effective and easy to implement on work machines as the controller 212 of the remote system 200 interfaces with existing sensors of the work machine 100 to control the engine 104 and the HVAC system 126.

Further, the remote system 200 verifies if it acceptable to turn ON the engine 104 and the HVAC system 126 by determining a state of the doors 118 and the windows 120, the current voltage of the battery system 122, the status of the parking brake 124, and the current temperature of the operator cabin 106 before turning ON the engine 104 and the HVAC system 126, which may improve a reliability of the remote system 200. Additionally, the controller 212 determines if the doors 118 and windows 120 are closed which may allow the temperature of the operator cabin 106 to be maintained within the desired temperature range T1 by ensuring adequate sealing of the operator cabin 106.

Further, the remote system 200 may turn OFF the engine 104 and the HVAC system 126 in case of an entry of operators into the operator cabin 106 before the elapse of the predefined time period TP1 in order to maintain optimal machine start conditions for operators. Moreover, the remote system 200 may turn OFF the engine 104 and the HVAC system 126 if the remote system 200 determines any unauthorized entry into the operator cabin 106 based on the first or second input signals I1, I2 received from the door lock sensor 202 or the window lock sensor 204, and the input signal I3 received from the key position relay 130. For example, in some situations, an unauthorized user may try to enter the operator cabin 106 by breaking the door 118 or the window 120. In such situations, if the controller 212 determines that the door 118 or the window 120 of the operator cabin 106 are open and the key position relay 130 does not indicate that the machine key was used to access the operator cabin 106, then the remote system 200 turns OFF the engine 104 and the HVAC system 126 to prevent unauthorized access to the work machine 100.

The remote system 200 described herein can be customized to communicate with the handheld electronic device equipped with a software application or a web page, or the remote-control key, as per customer's requirement. Moreover, the remote system 200 and the method 300 alerts personnel present in the surrounding of the work machine 100 before the engine 104 is turned ON by providing the alert A1, thereby allowing personnel to move away from the work machine 100, if required. Furthermore, the remote system 200 and the method 300 may improve environmental safety by providing the alert A1.

Further, as per the remote system 200 and the method 300, the engine 104 and the HVAC system 126 operate until the elapse of the predefined time period TP1, so that the temperature within the operator cabin 106 is within the desired temperature range T1 when the operator enters the operator cabin 106. Moreover, prior to the elapse of the predefined time period TP1, the notification N1 is sent to the user device 220 that the predefined time period TP1 is about to elapse and the engine 104 as well as the HVAC system 126 will be turned OFF thereafter. The operation of the engine 104 and the HVAC system 126 only until the elapse of the predefined time period TP1 may conserve fuel and battery power of the battery system 122.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

What is claimed is:

1. A remote system for regulating a temperature of an operator cabin of a work machine, the remote system comprising:
at least one door lock sensor coupled to at least one door of the work machine, the at least one door lock sensor is configured to generate a first input signal that indicates if the at least one door is open or closed;
at least one window lock sensor coupled to at least one window of the work machine, the at least one window lock sensor is configured to generate a second input signal that indicates if the at least one window is open or closed;
a temperature sensor disposed within the operator cabin, the temperature sensor is configured to generate a temperature signal that indicates a current temperature of the operator cabin;
a voltage detection sensor coupled to a battery system of the work machine, the voltage detection sensor is configured to generate a voltage signal that indicates a current voltage of the battery system;
a parking brake sensor coupled to the work machine, the parking brake sensor is configured to generate a parking brake signal that indicates if a parking brake of the work machine is in an applied state; and
a controller in communication with each of the at least one door lock sensor, the at least one window lock sensor, the temperature sensor, the voltage detection sensor, and the parking brake sensor, wherein the controller is configured to:
wirelessly receive, from a user, a user input to turn ON a heating, ventilation, and air-conditioning (HVAC) system 126 of the work machine;
determine whether the at least one door of the work machine is open or closed based on the first input signal received from the at least one door lock sensor;
determine whether the at least one window of the work machine is open or closed based on the second input signal received from the at least one window lock sensor;
determine whether the current temperature of the operator cabin is outside of a desired temperature range based on the temperature signal received from the temperature sensor;
determine whether the current voltage of the battery system is above a predetermined threshold based on the voltage signal received from the voltage detection sensor;
determine whether the parking brake of the work machine is in the applied state so as to prevent a movement of the work machine based on the parking brake signal received from the parking brake sensor;
turn ON a power source of the work machine if the at least one door is closed, the at least one window is closed, the current temperature of the operator cabin is outside of the desired temperature range, the current voltage of the battery system is above the predetermined threshold, and the parking brake of the work machine is in the applied state;
determine if the power source is in an operational state; and
turn ON the HVAC system of the work machine to regulate the current temperature of the operator cabin so as to lie within the desired temperature range if the power source is in the operational state.

2. The remote system of claim 1 further comprising an indication module in communication with the controller, wherein the controller is configured to transmit an output signal to the indication module before the power source is turned ON, and wherein, based on the output signal received from the controller, the indication module is configured to generate an alert before the power source is turned ON.

3. The remote system of claim 2, wherein the indication module is disposed externally relative to the operator cabin.

4. The remote system of claim 1, wherein the controller is configured to:
determine whether the current temperature of the operator cabin is within the desired temperature range based on the temperature signal received from the temperature sensor;
turn OFF the HVAC system if each of the current temperature of the operator cabin is within the desired temperature range and a predefined time period has elapsed from turning ON of the HVAC system; and
turn OFF the power source if each of the current temperature of the operator cabin is within the desired temperature range and the predefined time period has elapsed from turning ON of the HVAC system.

5. The remote system of claim 1, wherein the controller is configured to:
determine whether the at least one door of the work machine is open based on the first input signal received from the at least one door lock sensor and/or the at least one window of the work machine is open based on the second input signal received from the at least one window lock sensor, while each of the power source and the HVAC system is ON;
determine whether the current temperature of the operator cabin is outside the desired temperature range based on the temperature signal received from the temperature sensor;
turn OFF the HVAC system if the at least one door of the work machine is open and/or the at least one window of the work machine is open even if the current temperature of the operator cabin is outside the desired temperature range; and
turn OFF the power source if the at least one door of the work machine is open and/or the at least one window of the work machine is open even if the current temperature of the operator cabin is outside the desired temperature range.

6. The remote system of claim 1, wherein the controller is configured to:
determine whether any one of:
the at least one door is open based on the first input signal received from the at least one door lock sensor,
the at least one window is open based on the second input signal received from the at least one window lock sensor,
the current temperature of the operator cabin is within the desired temperature range based on the temperature signal received from the temperature sensor,
the current voltage of the battery system is below the predetermined threshold based on the voltage signal received from the voltage detection sensor, and
the parking brake of the work machine is not in the applied state based on the parking brake signal received from the parking brake sensor; and
transmit a notification to a user device to indicate that the power source has not been turned ON if any one of: the at least one door is open, the at least one window is open, the current temperature of the operator cabin is within the desired temperature range, the current voltage of the battery system is below the predetermined threshold, and the parking brake of the work machine is not in the applied state.

7. The remote system of claim 6, wherein the controller is configured to wirelessly receive the user input from the user device present with the user, and wherein the user device includes a handheld electronic device or a remote-control key.

8. The remote system of claim 1, wherein each of the at least one door lock sensor and the at least one window lock sensor includes any one of a pressure sensor, a capacitive sensor, a load sensor, a force sensor, and a touch sensor.

9. A method for remotely regulating a temperature of an operator cabin of a work machine, the method comprising:
generating, by at least one door lock sensor coupled to at least one door of the work machine, a first input signal that indicates if the at least one door is open or closed;
generating, by at least one window lock sensor coupled to at least one window of the work machine, a second input signal that indicates if the at least one window is open or closed;
generating, by a temperature sensor disposed within the operator cabin, a temperature signal that indicates a current temperature of the operator cabin;
generating, by a voltage detection sensor coupled to a battery system of the work machine, a voltage signal that indicates a current voltage of the battery system;
generating, by a parking brake sensor coupled to the work machine, a parking brake signal that indicates if a parking brake of the work machine is in an applied state;
wirelessly receiving, by a controller, a user input to turn ON a heating, ventilation, and air-conditioning (HVAC) system of the work machine from a user, wherein the controller is in communication with each of the at least one door lock sensor, the at least one window lock sensor, the temperature sensor, the voltage detection sensor, and the parking brake sensor;
determining, by the controller, whether the at least one door of the work machine is open or closed based on the first input signal received from the at least one door lock sensor;
determining, by the controller, whether the at least one window of the work machine is open or closed based on the second input signal received from the at least one window lock sensor;
determining, by the controller, whether the current temperature of the operator cabin is outside of a desired temperature range based on the temperature signal received from the temperature sensor;
determining, by the controller, whether the current voltage of the battery system is above a predetermined threshold based on the voltage signal received from the voltage detection sensor;
determining, by the controller, whether the parking brake of the work machine is in the applied state so as to prevent a movement of the work machine based on the parking brake signal received from the parking brake sensor;
turning ON, by the controller, a power source of the work machine if the at least one door is closed, the at least one window is closed, the current temperature of the operator cabin is outside of the desired temperature range, the current voltage of the battery system is above the predetermined threshold, and the parking brake of the work machine is in the applied state;
determining, by the controller, if the power source is in an operational state; and
turning ON, by the controller, the HVAC system of the work machine to regulate the current temperature of the operator cabin so as to lie within the desired temperature range if the power source is in the operational state.

10. The method of claim 9 further comprising:
transmitting, by the controller, an output signal to an indication module before turning ON the power source, wherein the indication module is in communication with the controller, and wherein the indication module is disposed externally relative to the operator cabin; and
generating, by the indication module, an alert before the power source is turned ON based on the output signal received from the controller.

11. The method of claim 9 further comprising:
determining, by the controller, whether the current temperature of the operator cabin is within the desired temperature range based on the temperature signal received from the temperature sensor;
turning OFF, by the controller, the HVAC system if each of the current temperature of the operator cabin is within the desired temperature range and a predefined time period has elapsed from turning ON of the HVAC system; and
turning OFF, by the controller, the power source if each of the current temperature of the operator cabin is within the desired temperature range and the predefined time period has elapsed from turning ON of the HVAC system.

12. The method of claim 9 further comprising:
determining, by the controller, whether the at least one door of the work machine is open based on the first input signal received from the at least one door lock sensor and/or the at least one window of the work machine is open based on the second input signal received from the at least one window lock sensor, while each of the power source and the HVAC system is ON;
determining, by the controller, whether the current temperature of the operator cabin is outside the desired temperature range based on the temperature signal received from the temperature sensor;
turning off, by the controller, the HVAC system if the at least one door of the work machine is open and/or the at least one window of the work machine is open even if the current temperature of the operator cabin is outside the desired temperature range; and
turning OFF, by the controller, the power source if the at least one door of the work machine is open and/or the at least one window of the work machine is open even if the current temperature of the operator cabin is outside the desired temperature range.

13. The method of claim 9 further comprising:
determining, by the controller, whether any one of:
the at least one door is open based on the first input signal received from the at least one door lock sensor,
the at least one window is open based on the second input signal received from the at least one window lock sensor,
the current temperature of the operator cabin is within the desired temperature range based on the temperature signal received from the temperature sensor,
the current voltage of the battery system is below the predetermined threshold based on the voltage signal received from the voltage detection sensor, and
the parking brake of the work machine is not in the applied state based on the parking brake signal received from the parking brake sensor; and
transmitting, by the controller, a notification to a user device to indicate that the power source has not been turned ON if any one of: the at least one door is open, the at least one window is open, current temperature of the operator cabin is within the desired temperature range, current voltage of the battery system is below the predetermined threshold, and the parking brake of the work machine is not in the applied state.

14. The method of claim 13 further comprising wirelessly receiving, by the controller, the user input from the user device present with the user, wherein the user device includes a handheld electronic device or a remote-control key.

15. A work machine comprising:
a frame;
a power source mounted on the frame and configured to provide an operating power supply to one or more components of the work machine;
an operator cabin mounted on the frame;
at least one door coupled to the operator cabin;
at least one window coupled to the operator cabin;
a battery system configured to provide an electric power supply to one or more components of the work machine;
a parking brake;
a heating, ventilation, and air-conditioning (HVAC) system configured to at least one of heat and cool the operator cabin; and
a remote system for regulating a temperature of the operator cabin, the remote system including:
at least one door lock sensor coupled to at least one door of the work machine, the at least one door lock sensor is configured to generate a first input signal that indicates if the at least one door is open or closed;
at least one window lock sensor coupled to at least one window of the work machine, the at least one window lock sensor is configured to generate a second input signal that indicates if the at least one window is open or closed;
a temperature sensor disposed within the operator cabin, the temperature sensor is configured to generate a temperature signal that indicates a current temperature of the operator cabin;
a voltage detection sensor coupled to the battery system of the work machine, the voltage detection sensor is configured to generate a voltage signal that indicates a current voltage of the battery system;
a parking brake sensor coupled to the work machine, the parking brake sensor is configured to generate a parking brake signal that indicates if the parking brake of the work machine is in an applied state; and
a controller in communication with each of the at least one door lock sensor, the at least one window lock sensor, the temperature sensor, the voltage detection sensor, and the parking brake sensor, wherein the controller is configured to:
wirelessly receive, from a user, a user input to turn ON the HVAC system of the work machine;
determine whether the at least one door of the work machine is open or closed based on the first input signal received from the at least one door lock sensor;
determine whether the at least one window of the work machine is open or closed based on the second input signal received from the at least one window lock sensor;
determine whether the current temperature of the operator cabin is outside of a desired temperature range based on the temperature signal received from the temperature sensor;
determine whether the current voltage of the battery system is above a predetermined threshold based on the voltage signal received from the voltage detection sensor;
determine whether the parking brake of the work machine is in the applied state so as to prevent a movement of the work machine based on the parking brake signal received from the parking brake sensor;
turn ON the power source of the work machine if the at least one door is closed, the at least one window is closed, the current temperature of the operator cabin is outside of the desired temperature range, the current voltage of the battery system is above the predetermined threshold, and the parking brake of the work machine is in the applied state;
determine if the power source is in an operational state; and
turn ON the HVAC system of the work machine to regulate the current temperature of the operator cabin so as to lie within the desired temperature range if the power source is in the operational state.

16. The work machine of claim 15, wherein the remote system further includes an indication module in communication with the controller, wherein the controller is configured to transmit an output signal to the indication module before the power source is turned ON, and wherein, based on the output signal received from the controller, the indication module is configured to generate an alert before the power source is turned ON.

17. The work machine of claim 15, wherein the controller is configured to:
determine whether the current temperature of the operator cabin is within the desired temperature range based on the temperature signal received from the temperature sensor;
turn OFF the HVAC system if each of the current temperature of the operator cabin is within the desired temperature range and a predefined time period has elapsed from turning ON of the HVAC system; and
turn OFF the power source if each of the current temperature of the operator cabin is within the desired temperature range and the predefined time period has elapsed from turning ON of the HVAC system.

18. The work machine of claim 15, wherein the controller is configured to:
determine whether the at least one door of the work machine is open based on the first input signal received from the at least one door lock sensor and/or the at least one window of the work machine is open based on the second input signal received from the at least one window lock sensor, while each of the power source and the HVAC system is ON;
determine whether the current temperature of the operator cabin is outside the desired temperature range, based on the temperature signal received from the temperature sensor;
turn OFF the HVAC system if the at least one door of the work machine is open and/or the at least one window of the work machine is open even if the current temperature of the operator cabin is outside the desired temperature range; and
turn OFF the power source if the at least one door of the work machine is open and/or the at least one window of the work machine is open even if the current temperature of the operator cabin is outside the desired temperature range.

19. The work machine of claim 15, wherein the controller is configured to:
determine whether any one of:
the at least one door is open based on the first input signal received from the at least one door lock sensor,
the at least one window is open based on the second input signal received from the at least one window lock sensor,
the current temperature of the operator cabin is within the desired temperature range based on the temperature signal received from the temperature sensor,
the current voltage of the battery system is below the predetermined threshold based on the voltage signal received from the voltage detection sensor, and
the parking brake of the work machine is not in the applied state based on the parking brake signal received from the parking brake sensor; and
transmit a notification to a user device to indicate that the power source has not been turned ON if any one of: the at least one door is open, the at least one window is open, the current temperature of the operator cabin is within the desired temperature range, the current voltage of the battery system is below the predetermined threshold, and the parking brake of the work machine is not in the applied state.

20. The work machine of claim 19, wherein the controller is configured to wirelessly receive the user input from the user device present with the user, and wherein the user device includes a handheld electronic device or a remote-control key.
